(19) United States
(12) Patent Application Publication
(10) Pub. No.: US 2011/0243449 A1
(43) Pub. Date: Oct. 6, 2011

(54) METHOD AND APPARATUS FOR OBJECT IDENTIFICATION WITHIN A MEDIA FILE USING DEVICE IDENTIFICATION

(75) Inventors: Miska Hannuksela, Ruutana (FI); Antti Eronen, Tampere (FI)

(73) Assignee: Nokia Corporation, Espoo (FI)

(21) Appl. No.: 12/751,638

(22) Filed: Mar. 31, 2010

(51) Int. Cl. G06K 9/46

(52) U.S. Cl. 382/190

(57) ABSTRACT

A method, apparatus, and computer program product are therefore provided for identifying a person or people in a media file by using object recognition and near-field communication to detect nearby devices that may be associated with a person or people featured in the media file. Associating a nearby device with a person or people featured in a media file may add to the confidence level with which a person is identified within a media file using object recognition, which may include facial recognition and/or speaker recognition.

### TECHNOLOGICAL FIELD

Embodiments of the present invention relate generally to computing technology and, more particularly, relate to methods and apparatus for identifying an object, such as a person, in an environment using device identification and, in one embodiment, object recognition, such as object recognition based on visual and/or audio information.

### BACKGROUND

The modern communications era has brought about a tremendous expansion of wireline and wireless networks. Computer networks, television networks, and telephone networks are experiencing an unprecedented technological expansion, fueled by consumer demand. Wireless and mobile networking technologies have addressed related consumer demands, while providing more flexibility and immediacy of information transfer.

Communications transmitted over networks have progressed from voice calls to data transfers that can transfer virtually limitless forms of data to any location on a network. Commensurately, devices that communicate over these networks have become increasingly capable and feature functions that allow devices to capture pictures, videos, access the Internet, determine physical location, and play music among many other functions. Social networking applications have also led to the increase in sharing personal information and media files over networks.

Social networking over the Internet has also seen unprecedented growth recently such that millions of people have personal profiles online where they may attach or post pictures, videos, or comments about friends or other people with online profiles. It is often desirable in these pictures or videos to identify the individuals featured in the pictures such that they may be “linked” to the picture or such that someone can find pictures of a person of interest. Identifying people in these videos or pictures is often performed manually by associating a person's profile with a region of the picture or video.

Mobile devices are often used to create the pictures or videos that are attached to a person's social networking profile and it may be desirable to enhance the way in which a user can take pictures and video and more quickly and easily upload them to a personal profile. It may also be desirable to enhance the method in which people in the picture or video are identified to make the process less user-intensive.

### BRIEF SUMMARY

A method, apparatus, and computer program product are therefore provided for identifying a person or people in a media file by using object recognition and near-field communication to detect nearby devices that may be associated with a person or people featured in the media file. Associating a nearby device with a person or people featured in a media file may add to the confidence level with which a person is identified within a media file using object recognition, which may include facial recognition and/or speaker recognition.

In one embodiment of the present invention, a method is provided that includes receiving a first media file, identifying a first nearby device using near-field communication, and analyzing the first media file to identify an object within the first media file based on the identification of the first nearby device. The analyzing may include object recognition, such as facial recognition or speaker recognition. The analyzing may include increasing the likelihood of recognizing a first object associated with the first nearby device. The method may further include generating a probability that is based upon the likelihood of the first object being correctly recognized. The method may further comprise associating the first media file with the first object. Embodiments of the method may include capturing a second media file and identifying a second nearby device using near-field communications, wherein the analyzing includes deriving similarity between the first media file and the second media file. The similarity may be increased when the first nearby device and the second nearby device are the same or associated with the same object.

According to another embodiment of the invention, an apparatus is provided that includes at least one processor and at least one memory including computer program code. The at least one memory and the computer program code are configured to, with the at least one processor, cause the apparatus to receive a first media file, identify a first nearby device using near-field communication, and analyze the first media file to identify an object within the first media file based on the identification of the first nearby device. The analyzing may include object recognition. The analyzing may include increasing the likelihood of recognizing a first object associated with the first nearby device. The apparatus may be caused to generate a probability that is based upon the likelihood of the first object being correctly recognized. The apparatus may also be caused to associate the first media file with the first object. Embodiments of the apparatus may further be caused to capture a second media file and identify a second nearby device using near-field communication, wherein analyzing includes deriving similarity between the first media file and the second media file. The similarity may be increased when the first nearby device and the second nearby device are the same or associated with the same object.

According to yet another embodiment of the invention, a computer program product is provided that includes at least one computer-readable storage medium having computer-executable program code instructions stored therein. The computer-executable program code instructions of this embodiment include program code instructions for receiving a first media file, program code instructions for identifying a first nearby device using near-field communication, and program code instructions for analyzing the first media file to identify an object within the first media file based on the identification of the first nearby device. The program code instructions for analyzing the first media file may include program code instructions for object recognition. The program code instructions for analyzing the first media file may include increasing the likelihood of recognizing a first object associated with the first nearby device. The computer program product may include program code instructions for generating a probability that is based upon the likelihood of the first object being correctly recognized. The computer program product may include program code instructions for capturing a second media file and program code instructions for identifying a second nearby device using near-field communication, wherein the analyzing includes deriving similarity between the first media file and the second media file. The similarity may be increased when the first nearby device and the second nearby device are the same or associated with the same object.

### BRIEF DESCRIPTION OF THE SEVERAL VIEWS OF THE DRAWING(S)

Having thus described embodiments of the invention in general terms, reference now will be made to the accompanying drawings, which are not necessarily drawn to scale, and wherein:

FIG. 1 is a block diagram of a mobile device, according to one embodiment of the present invention;

FIG. 2 is a schematic representation of a system for supporting embodiments of the present invention;

FIG. 3 is a Venn-diagram representation of a method according to an example embodiment of the present invention;

FIG. 4 is a flow chart of the operations performed in accordance with one embodiment of the present invention; and

FIG. 5 is a flow chart of the operations performed in accordance with another embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

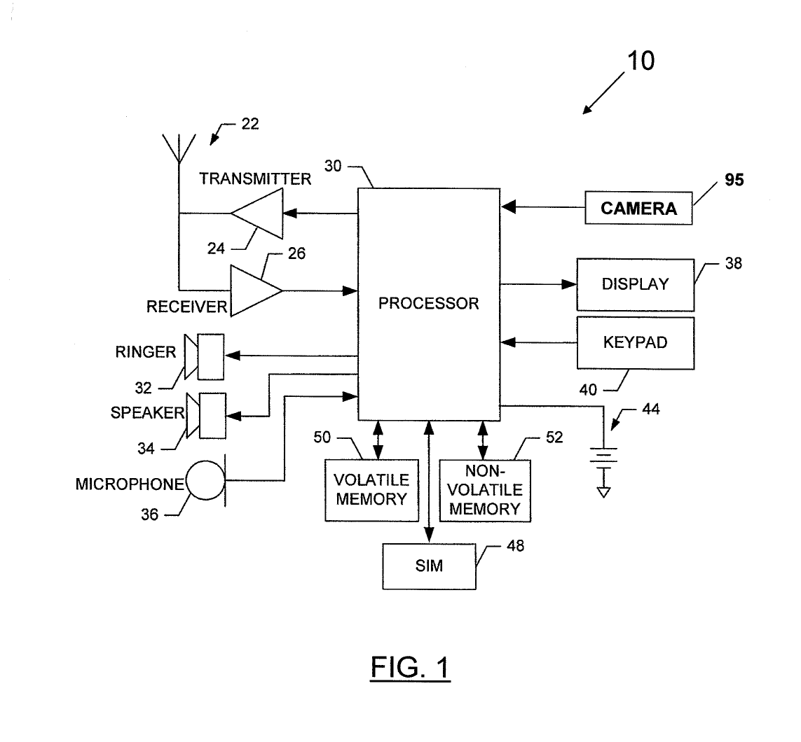

Although a mobile device may be configured in various manners, one example of a mobile device that could benefit from embodiments of the invention is depicted in the block diagram of FIG. 1. While one embodiment of a mobile device will be illustrated and hereinafter described for purposes of example, other types of mobile devices, such as portable digital assistants (PDAs), pagers, mobile televisions, gaming devices, all types of computers (e.g., laptops or mobile computers), cameras, audio/video players, radios, or any combination of the aforementioned, and other types of mobile devices, may employ embodiments of the present invention. As described, the mobile device may include various means for performing one or more functions in accordance with embodiments of the present invention, including those more particularly shown and described herein. It should be understood, however, that a mobile device may include alternative means for performing one or more like functions, without departing from the spirit and scope of the present invention.

The mobile device 10 of the illustrated embodiment includes an antenna 22 (or multiple antennas) in operable communication with a transmitter 24 and a receiver 26. The mobile device may further include an apparatus, such as a processor 30, that provides signals to and receives signals from the transmitter and receiver, respectively. The signals may include signaling information in accordance with the air interface standard of the applicable cellular system, and/or may also include data corresponding to user speech, received data and/or user generated data. In this regard, the mobile device may be capable of operating with one or more air interface standards, communication protocols, modulation types, and access types. By way of illustration, the mobile device may be capable of operating in accordance with any of a number of first, second, third and/or fourth-generation communication protocols or the like. For example, the mobile device may be capable of operating in accordance with second-generation (2G) wireless communication protocols IS-136, global system for mobile communications (GSM) and IS-95, or with third-generation (3G) wireless communication protocols, such as universal mobile telecommunications system (UMTS), code division multiple access 2000 (CDMA2000), wideband CDMA (WCDMA) and time division-synchronous code division multiple access (TD-SCDMA), with 3.9G wireless communication protocol such as E-UTRAN (evolved-UMTS terrestrial radio access network), with fourth-generation (4G) wireless communication protocols or the like. The mobile device may also be capable of operating in accordance with local and short-range communication protocols such as wireless local area networks (WLAN), Bluetooth (BT), Bluetooth Low Energy (BT LE), ultra-wideband (UWB), radio frequency (RF), and other near field communications (NFC).

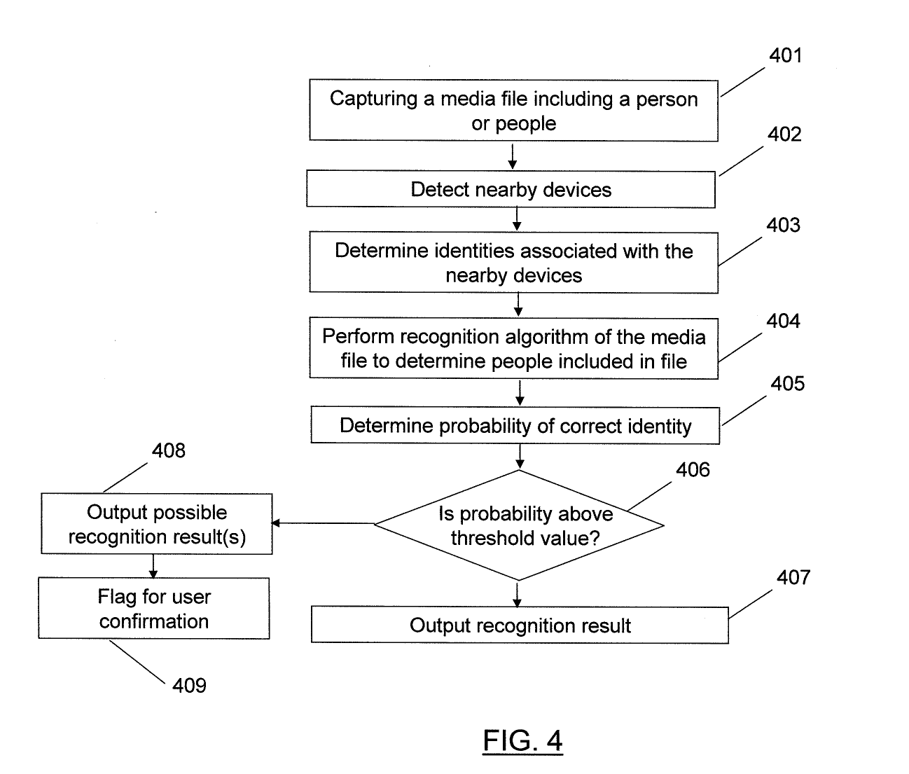

It is understood that the apparatus, such as the processor 30, may include circuitry implementing, among others, audio and logic functions of the mobile device 10. The processor may be embodied in a number of different ways. For example, the processor may be embodied as various processing means such as processing circuitry, a coprocessor, a controller or various other processing devices including integrated circuits such as, for example, an ASIC (application specific integrated circuit), an FPGA (field programmable gate array), a hardware accelerator, and/or the like. In an example embodiment, the processor is configured to execute instructions stored in a memory device or otherwise accessible to the processor. As such, whether configured by hardware or software methods, or by a combination thereof, the processor 30 may represent an entity capable of performing operations according to embodiments of the present invention, including those depicted in FIGS. 4 and/or 5, while specifically configured accordingly. The processor may also include the functionality to convolutionally encode and interleave message and data prior to modulation and transmission.

The mobile device 10 may also comprise a user interface including an output device such as an earphone or speaker 34, a ringer 32, a microphone 36, a display 38 (including normal and/or bistable displays), and a user input interface, which may be coupled to the processor 30. The user input interface, which allows the mobile device to receive data, may include any of a number of devices allowing the mobile device to receive data, such as a keypad 40, a touch display (not shown) or other input device. In embodiments including the keypad, the keypad may include numeric (0-9) and related keys (#, *), and other hard and soft keys used for operating the mobile device. Alternatively, the keypad may include a conventional QWERTY keypad arrangement. The keypad may also include various soft keys with associated functions. In addition, or alternatively, the mobile device may include an interface device such as a joystick or other user input interface. The mobile device may further include a battery 44, such as a vibrating battery pack, for powering various circuits that are used to operate the mobile device, as well as optionally providing mechanical vibration as a detectable output. The mobile device 10 may further include a camera 95 or lens configured to capture images (still images or videos). The camera 95 may operate in concert with the microphone 36 to capture a video media file with audio which may be stored on the device, such as in memory 52, or transmitted via a network. The mobile device 10 may be considered to “capture” a media file or “receive” a media file as the media is transferred from the lens of a camera 95 to a processor 30.

The mobile device 10 may further include a user identity module (UIM) 48, which may generically be referred to as a smart card. The UIM may be a memory device having a processor built in. The UIM may include, for example, a subscriber identity module (SIM), a universal integrated circuit card (UICC), a universal subscriber identity module (USIM), a removable user identity module (R-UIM), or any other smart card. The UIM may store information elements related to a mobile subscriber. In addition to the UIM, the mobile device may be equipped with memory. For example, the mobile device may include volatile memory 50, such as volatile Random Access Memory (RAM) including a cache area for the temporary storage of data. The mobile device may also include other non-volatile memory 52, which may be embedded and/or may be removable. The non-volatile memory may additionally or alternatively comprise an electrically erasable programmable read only memory (EEPROM), flash memory or the like. The memories may store any of a number of pieces of information, and data, used by the mobile device to implement the functions of the mobile device. For example, the memories may include an identifier, such as an international mobile equipment identification (IMEI) code, capable of uniquely identifying the mobile device.

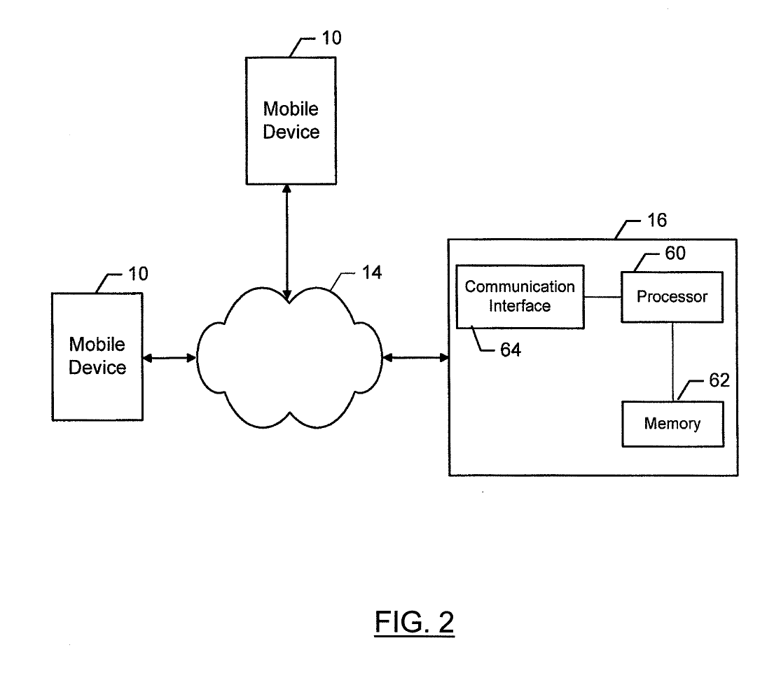

The mobile device 10 may be configured to communicate via a network 14 with a network entity 16, such as a server as shown in FIG. 2, for example. The network may be any type of wired and/or wireless network that is configured to support communications between various mobile devices and various network entities. For example, the network may include a collection of various different nodes, devices or functions such as the server, and may be in communication with each other via corresponding wired and/or wireless interfaces. Server functionality may reside, for example, in an overlay network or a gateway such as Nokia's Ovi service. Although not necessary, in some embodiments the network may be capable of supporting communications in accordance with any one of a number of first-generation (1G), second-generation (2G), 2.5G, third-generation (3G), 3.5G, 3.9G, fourth-generation (4G) level communication protocols, long-term evolution (LTE) and/or the like.

As shown in FIG. 2, a block diagram of a network entity 16 capable of operating as a server or the like is illustrated in accordance with one embodiment of the present invention. The network entity may include various means for performing one or more functions in accordance with embodiments of the present invention, including those more particularly shown and described herein. It should be understood, however, that the network entity may include alternative means for performing one or more like functions, without departing from the spirit and scope of the present invention.

In the illustrated embodiment, the network entity 16 includes means, such as a processor 60, for performing or controlling its various functions. The processor may be embodied in a number of different ways. For example, the processor may be embodied as various processing means such as processing circuitry, a coprocessor, a controller or various other processing devices including integrated circuits such as, for example, an ASIC, an FPGA, a hardware accelerator, and/or the like. In an example embodiment, the processor is configured to execute instructions stored in memory or otherwise accessible to the processor. As such, whether configured by hardware or software methods, or by a combination thereof, the processor 60 may represent an entity capable of performing operations according to embodiments of the present invention while specifically configured accordingly.

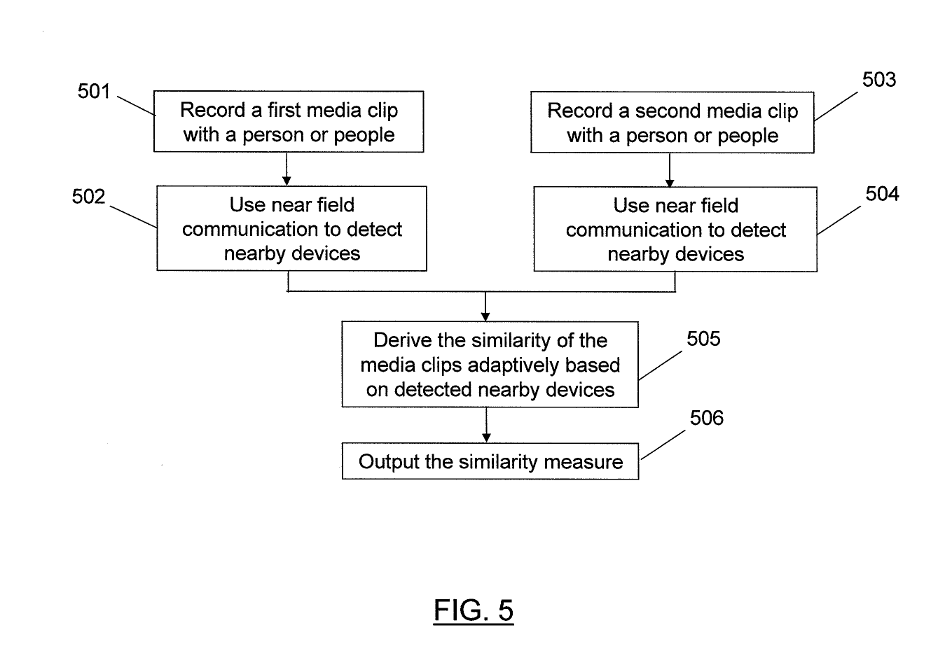

In one embodiment, the processor 60 is in communication with or includes memory 62, such as volatile and/or non-volatile memory that stores content, data or the like. For example, the memory may store content transmitted from, and/or received by, the network entity. Also for example, the memory may store software applications, instructions or the like for the processor to perform operations associated with operation of the network entity 16 in accordance with embodiments of the present invention. In particular, the memory may store software applications, instructions or the like for the processor to perform the operations described above and below with regard to FIGS. 5 and 6. In addition to the memory 62, the processor 60 may also be connected to at least one interface or other means for transmitting and/or receiving data, content or the like. In this regard, the interface(s) can include at least one communication interface 64 or other means for transmitting and/or receiving data, content or the like, such as between the network entity 16 and the mobile device 10 and/or between the network entity and the remainder of network 14.

Mobile devices, such as 10 of FIG. 1, may be configured to display or present various forms of multimedia (e.g., video, audio, pictures, etc.) to a user. The multimedia may be in the form of a file that is received by the device or streaming data that is received by the device. Mobile devices may also be configured to receive or record data, such as multimedia or other forms of data as will be discussed below, and transmit the data elsewhere for presentation. Accessories for mobile devices, such as cameras, microphones, or the like may be configured to receive data and transmit the data via Bluetooth or other communications protocols or stored on the mobile device 10 itself, such as in memory 52. A mobile device may capture or record a media file and a processor of the mobile device may receive the data for execution of embodiments of the present invention.

By way of example, a mobile device may capture or record a multimedia file, such as a still picture, an audio recording, a video recording, or a recording with both video and audio. A mobile device, such as 10, may capture a video or picture via camera 95 and related audio through microphone 36. The multimedia file, or media file, may be stored on the device in the memory 52, transmitted by the transmitter 24, or both. A video recording may be a series of still pictures taken at a picture rate to create a moving image. The picture rate being selected based on the desired size of the multimedia file and the desired quality. Resolution of the picture or series of pictures in a video recording may also be adjustable for quality and size purposes. Audio recordings may also have a sample rate or frequency that is variable to create a multimedia file of a desired size and/or quality. As used herein, video may refer to either a moving picture (e.g., series of pictures collected at a picture rate) or a still picture. While embodiments of the invention will be described herein as a mobile device that both captures the media file and performs a method according to embodiments of the invention, the capturing of a media file may be performed by a first device while methods according to embodiments of the invention may be performed on a device separate from the capture device. An example of which may include a mobile device with a Bluetooth® headset camera which may lack the processing capabilities to execute embodiments of the present invention. It may, however, be desirable that the capture device and the device executing embodiments of the present invention may be in relatively close proximity due to the nature of the invention.

Media files may often record images and/or audio of people and it may be desirable to automatically (e.g., without operator intervention) identify the individuals that have been recorded in the media file. Identification of the individuals within the media file may allow a file to be associated with a person over a social networking website or linked to a person through searches of a network, such as the Internet. Such associations allow users to select individuals or groups of people and retrieve media files that may contain these people. For example, a person may wish to find media files containing video or audio of themselves with a specific friend or family member. This association of individuals with media in which they are featured facilitates an effective search for all of such files without having to review media files individually.

Speaker recognition tools are available that may associate a voice with an individual; however, these tools may search for a single voice in a database of hundreds, or thousands of known voice patterns. Such searches may be time consuming and may sometimes be inaccurate, particularly when the audio recording is of poor quality or if the voice of the individual is altered by inflection or tone-of-voice. Similarly, facial recognition tools are available that detect a face, and perhaps characteristics of a face. These recognition tools may compare a face from a video to a database of potentially millions of individuals which may lead to some probability of error, particularly when the video is of low quality or resolution, low light, or at an obscure angle that does not depict the facial characteristics of the individual very well. Further, these speaker and face recognition tools may require application subsequent to the recording of the multimedia file adding an additional step to the process of identifying individuals featured in the multimedia files. The database of potential matches for either speaker recognition or facial recognition may be stored locally on a device that is capturing a media file, or on another device within a network that may be accessed by the device.

Example embodiments of the present invention provide a method of accurately identifying individuals being captured in a media file (e.g. audio and/or video) either during the recording/capture process or subsequently. Embodiments of the present invention may be implemented on any device configured for audio and/or video capture or a device that receives a media file captured by another device. In one embodiment, a user of such a device may initiate a recording of a media file such as a picture, video, or audio clip that features a person or group of people. For a media file that includes video or other pictures, a face recognition algorithm may be used (in the case of a video recording) to match each person featured to a person known to the device (e.g., in a user's address book or contact list) or a person available in a database which may be embodied on the device itself, or located remotely, such as on a network. These features may be extracted from the recorded media file and matched against stored models. The device may then store a template or model, such as facial feature vectors, for each known person and annotate the video with an identifier of the individuals featured in the video. The video recording may also be stored in a distributed fashion, for example, some metadata (e.g., feature vectors and annotation) in the device, while the actual content is stored in another device, such as a network access point.

The facial recognition algorithm may also include a probability factor for individuals believed to be featured in the video. The probability factor may use both feature vector correlation with a known face and a relevance factor. The relevance factor may be determined from the contact list or address book of the user of the device such that a contact that is frequently used (e.g., contacted via e-mail, SMS text message, phone call, etc.) may carry a higher relevance factor than someone in the contact list that is not contacted very often, presuming that a more frequent contact is more likely to be featured in a video recorded by the user of the device. Another factor that may be included within the relevance factor may be an association with others known to be featured in the video recording. For example, if an individual that is a possible match according to the facial algorithm is associated with a “family” group within a user's contact list and the facial recognition algorithm has detected another member of the “family” group in the same video with high probability, then members of the “family” group may be given added weight in determining the relevance factor.

A similar process as described above with respect to the facial recognition within a video recording may be used with an audio recording or the audio portion of an audio/video recording. A sequence of feature vectors may be extracted from an audio recording containing speech of the person to be recognized. As an example, the features may be mel-frequency cepstral coefficients (MFCC). The feature vectors may then be compared to models or templates of individuals stored on the device or elsewhere. As an example, each individual may be represented with a speaker model. More specifically, the speaker model may be a Gaussian mixture model, which is a well suitable model for modeling the distribution of feature vectors extracted from human voice. In a training stage, the Gaussian mixture model parameters may be trained, e.g., with the expectation maximization algorithm, by using a sequence of feature vectors extracted from an audio clip that contains speech from the person currently being trained. The GMM model parameters comprise the means, variances, and weights of the mixture densities. Given a sequence of feature vectors, and the GMM parameters of each speaker model trained in the system, one can then evaluate the likelihood of each person having produced the speech. As another alternative, rather than feature vectors, an audio recognition algorithm may correlate speech patterns, frequencies, cadence, and other elements of a person's voice pattern to match a voice with an individual. A similar relevance factor may also be used with the speaker recognition algorithm. This relevance factor may be e.g. the likelihood produced by the speaker model. Voice information for individuals may also be associated with those in a list of contacts on a device as well as on a database in or accessible to the device. In one embodiment, the voice information comprises the GMM speaker model parameters.

Near-field communications include Bluetooth®, Zigbee®, WLAN, etc. Near-field communications protocols include finding, detection, and identification of devices in the proximity. The device identification information or code may be associated with an owner or user of the device through various means. For example, the owner or user of the device may report the association of his/her identity and the device identification code to a database in a server, a social networking application, or a website. Another means is to include the device identification code in an electronic business card, a signature, or any other collection of contact information of the owner or the user of the device. The owner or the user of the device can distribute the electronic business card, the signature, or the other collection of contact information by various means, such as e-mail, SMS text message, and over near-field communications channel.

In addition to facial and speaker recognition, another element may be included to further resolve the identity of an individual within a media file recording. The device capturing, recording, or receiving the media file may include a near-field communications means to detect, find, and identify nearby devices. Detected devices are associated with identities, which may be performed through referencing a database of known devices stored on the device performing the recording or a database of known devices may be accessed on a network. Through the detection and identification of nearby devices and accessing the information associating a device identification information with an individual, the device capturing or receiving the media file may be able to ascertain the identities of individuals in proximity to the device and thus are considerably more likely to be featured in the multimedia file. The recognition of a nearby device may increase the probability factor of an individual associated with the nearby device being associated with one of the recognized faces or voices in the media file. Nearby may be defined herein to include within a range defined by the near-field communication method used and may vary depending on the environment and obstructions.

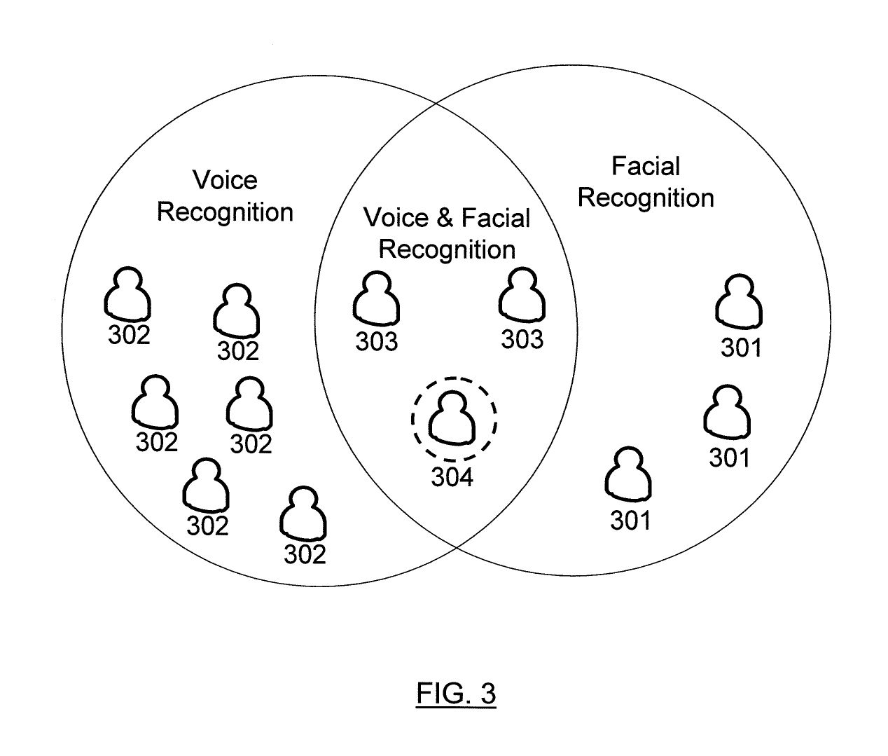

An example embodiment of the invention is illustrated in the Venn diagram of FIG. 3 and may include capturing an audio/video media file of a group of people. The facial recognition may detect a number of faces and may find a number of individuals 301 that are possible matches for each face detected. FIG. 3 represents the process of identifying a single person within the group of people in the media file and may be applied to each person individually. The facial recognition algorithm may assign a probability to each possible match; however this probability may not be sufficient to accurately and repeatably determine the identity of an individual featured in the media file. The speaker recognition algorithm may detect a number of voices and may find a number of individuals 302 that are possible matches for each voice identified. The facial recognition algorithm and speaker recognition algorithm may cooperate to determine if any individuals 303, 304 match both a facial profile and a voice profile. Each of these individuals that are possible matches with both the facial recognition algorithm and the speaker recognition algorithm may have a probability factor determined by their percentage match with the facial vectors or speech patterns, their group associations with the user of the device capturing the media file, or the frequency with which each may be contacted by the user of the device capturing the media file among others. This probability factor may not be decisive or high enough, such as greater than a predefined value and/or greater than the probability factor associated with any individual by at least a predefined amount to accurately and repeatably determine that the correct individual is identified, as each of the elements that factor into the probability factor may favor one individual over another. By virtue of detecting nearby user devices using near-field communication, the device of the user capturing the multimedia file may be able to determine with much greater certainty the identity of the individual featured in the multimedia file, such as the individual illustrated by 304, but not 303's device. In the illustrated embodiment, 303 and 304 represent people that may match a particular individual within the media file; however, the device capturing the media file, using near-field communication, detects a device associated with person 304 nearby, and thus, determines that person 304 is the identity of the individual in the media file. While the embodiment illustrated in FIG. 3 shows voice and facial recognition used, embodiments may include only speaker recognition or only facial recognition in addition to the nearby device recognition to determine identities. Embodiments of the present invention may include a time factor such that device detection may only occur during a certain time. For example, the time may be only during the capture (or reception) process of a video or within a predetermined time after a picture is taken.

Each of the aforementioned methods of determining the identity of an individual (facial recognition, speaker recognition, and device recognition) may not be sufficient of their own accord to produce an accurate result of the identity of an individual featured in a media file; however the combination of the methods may produce a significantly more accurate result than was previously attainable. In the case of a video recording with audio, speaker recognition and device recognition may indicate to the device capturing the video that a group of individuals are in the vicinity of the device; however, the facial recognition may pinpoint the location (time and/or location on a display) of an individual within the video recording. Identification of the location of an individual in the recording with respect to time may be useful for segmenting a video file into segments where particular individuals are featured. For example, if a video is recorded of a track-and-field race, a person may only wish to see the portions of a video in which the desired individual is depicted. The facial recognition algorithm may allow indexing of the video such that portions of the video in which the desired individual is not recognized by the facial recognition may be omitted while displaying portions of the video featuring the individual. The speaker recognition algorithm may also facilitate indexing of a multimedia file. For example, if a video with audio is recorded of a school play, a user may wish to only view portions in which the desired individual is speaking. The speaker recognition algorithm may index points at which the desired individual is speaking and facilitate display of only those portions in response to the user's request. Device recognition and association of the device to a user may be used to assist in the facial or speaker recognition based time segmentation of a multimedia file. If a device is recognized during a part of the multimedia file but not during its entire duration, the face or speaker recognition likelihood for the individual associated with the device may be increased when the device is detected in the proximity and decreased when the device is not detected in the proximity.

The multimedia file may be organized to include coded media streams, such as an audio stream and a video stream, a timed stream or a collection of feature vectors, such as audio feature vectors and facial feature vectors, and a timed stream of or a collection of device identification information or codes of the devices in the proximity of the recording device or the individuals associated with devices in the proximity of the recording device. For example, in a file organized according to the ISO base media file format, the file metadata related to an audio or video stream is organized in a structure called a media track, which refers to the coded audio or video data stored in a media data (mdat) box in the file. The file metadata for a timed stream of feature vectors and the device or individual information may be organized as one or more metadata tracks referring to the feature vectors and the device or individual information stored in a media data (mdat) box in the file. Alternatively or in addition, feature vectors and the device or individual information may be stored as sample group description entries and certain audio or video frames can be associated with particular ones of them using the sample-to-group box. Alternatively or in addition, feature vectors and the device or individual information may be stored as metadata items, which are not associated with a particular time period. The information on the individuals whose device has been in the proximity can be formatted as a name of the person (character string) or a Uniform Resource Identifier (URI) to the profile of the individual e.g. in a social network service or to the homepage of the individual. In addition, the output of the face recognition and speaker recognition may be stored a timed stream of or a collection, where the identified people and the likelihood of the identification result may be stored. The multimedia file need not be a single file but a collection of files associated with each other. For example, the ISO base media file format allows referring to external files, which may contain the coded audio and video data or the metadata such as the feature vectors or the device or individual information.

FIG. 4 is a flowchart of a method according to an example embodiment of the present invention. A media file, such as a video, is recorded at 401. The device performing the recording operation, such as a mobile device 10, may then detect nearby devices through a near-field communication method, such as Bluetooth® at 402. Detected devices are associated with identities at 403, which may be performed through referencing a database of known devices stored on the device performing the recording or a database of known devices may be accessed on a network. A network database that may include device identification may be a social networking application or website that includes mobile device identity together with other characteristics of a person's profile. A recognition algorithm, such as facial recognition and/or speaker recognition is performed at 404. Each person in the media file may be given a probability associated with their identity. The probability, calculated at 405, with respect to a particular identity may increase if a device associated with that individual is determined to be nearby. If the identity of a person by the recognition algorithm is determined with a high probability (e.g., above a threshold confidence, such as 90%) at 406, the person may be considered correctly identified and a recognition result may be recorded at 407. If the probability of correct identification is low (e.g., below a threshold confidence), then possible identification(s) may be output at 408 and the identifications may be flagged as unconfirmed for user confirmation at 409. The order of the above noted operations may be changed for different applications. Operation 404, wherein the recognition algorithm is performed, may be done before operation 402, such that if the recognition algorithm is able to determine the identity of a person or people with a high-level of confidence (e.g., greater than 95% certainty), the detection of nearby devices may not be necessary.

FIG. 5 illustrates a method according to another embodiment of the present invention. A user may record a first media file, such as a picture, a video, or an audio clip that includes a person or people on a device at 501. The device may then extract features from the first media file, such as facial feature vectors. The device may then use near-field communication to detect nearby devices and store the information regarding nearby devices, such as their identification codes, associated with the first media file at 502. A second media file may be recorded at 503 and nearby device information may be similarly stored at 504. At 505, the similarity between the media files may be measured. The measurement between media files may be performed, for example, in response to a user directing a search for media files similar to the first media file. The similarity between media files may be concluded based upon the extracted features. For example, a distance may be calculated between feature vectors extracted from the media files, and an inverse of the distance may then be used as a measure for similarity. In some embodiments, the distance may be a sum of a distance calculated between the visual features extracted from the visual (image) parts of the media clips and a distance calculated between the audio features extracted from the audio parts of the media files. Several distance metrics may be used, such as Euclidean distance, correlation distance, Manhattan distance, or a distance based on probabilistic measures such as the Kullback-Leibler divergence. Furthermore, the similarity may be derived according to the information regarding nearby devices found for each media file recorded. The similarity may be increased when the same nearby device is associated with both media files being compared. The similarity may be decreased if none of the nearby devices associated with the media files are common between the compared media files. The method may produce a similarity measure at 506 to illustrate the similarity between the compared media files.

As described above, FIGS. 4 and 5 are flowcharts of an apparatus, method and program product according to some exemplary embodiments of the invention. It will be understood that each block of the flowcharts, and combinations of blocks in the flowcharts, can be implemented by various means, such as hardware, firmware, and/or computer program product including one or more computer program instructions. For example, one or more of the procedures described above may be embodied by computer program instructions. In this regard, the computer program instructions which embody the procedures described above may be stored by a memory device, such as 50, 52, or 62, of a mobile device 10, network entity such as a server 16 or other apparatus employing embodiments of the present invention and executed by a processor 30, 60 in the mobile device, server or other apparatus. In this regard, the operations described above in conjunction with the diagrams of FIGS. 4 and 5 may have been described as being performed by the communications device and a network entity such as a server, but any or all of the operations may actually be performed by the respective processors of these entities, for example in response to computer program instructions executed by the respective processors. As will be appreciated, any such computer program instructions may be loaded onto a computer or other programmable apparatus (i.e., hardware) to produce a machine, such that the instructions which execute on the computer (e.g., via a processor) or other programmable apparatus implement the functions specified in the flowcharts block(s). These computer program instructions may also be stored in a computer-readable memory, for example, memory 62 of server 16, that can direct a computer (e.g., the processor or another computing device) or other apparatus to function in a particular manner, such that the instructions stored in the computer-readable memory produce an article of manufacture including instructions which implement the functions specified in the flowcharts block(s). The computer program instructions may also be loaded onto a computer or other apparatus to cause a series of operations to be performed on the computer or other apparatus to produce a computer-implemented process such that the instructions which execute on the computer or other programmable apparatus provide operations for implementing the functions specified in the flowcharts block(s).

Accordingly, blocks of the flowcharts support combinations of means for performing the specified functions, combinations of operations for performing the specified functions and program instructions for performing the specified functions. It will also be understood that one or more blocks of the flowcharts, and combinations of blocks in the flowcharts, can be implemented by special purpose hardware-based computer systems which perform the specified functions, operations, or combinations of special purpose hardware and computer instructions.

In an exemplary embodiment, an apparatus for performing the methods of FIGS. 4 and 5 may include a processor (e.g., the processor(s) 30 and/or 60) configured to perform some or each of the operations (401-409 and/or 501-506) described above. The processor(s) may, for example, be configured to perform the operations (401-409 and/or 501-506) by performing hardware implemented logical functions, executing stored instructions, or executing algorithms for performing each of the operations. Alternatively, the apparatus, for example server 16 and mobile device 10, may comprise means for performing each of the operations described above. In this regard, according to an example embodiment, examples of means for performing operations 401-409 and/or 501-506 may comprise, for example, the processor(s) 30 and/or 60 as described above.

In another exemplary embodiment, more than one apparatuses performs the methods of FIGS. 4 and 5 in collaboration. Each one of these apparatuses may be configured to perform some of the operations (401-409 and/or 501-506) described above. For example, a first apparatus, such as a mobile device 10, may capture a media file (401) and detect nearby devices (402), while a second apparatus, such as a server 16, may perform the remaining operations (403-409). Some of the individual operations may be performed in collaboration of more than one apparatuses. For example, facial or audio feature vectors may be extracted as a part of the recognition algorithm 404 by a first device, while the remaining of the recognition algorithm 404 may be performed by a second device. The first media clip and the second media clip in FIG. 5 may be captured by a first device and a second device, respectively, while operations for the similarity derivation and output (505-506) may be performed by a third device. Many other ways of performing the operations (401-409 and/or 501-506) by more than one apparatus are also possible.

It is noted that the means to detect nearby devices may not be triggered by the recording of a media file in the embodiments above. Rather, the means to detect nearby devices may always be activated. Optionally, the means to detect nearby devices may be activated when the user is preparing to record a media file (e.g., when the camera application has been launched or a manual shutter opened). The nearby devices may be detected approximately or exactly at the time a media files is recorded.

It should also be noted that identification of individuals featured in media files is described above as occurring at the time of recording; however, it is possible to perform person identification separately, possibly on another device. If the algorithms involved are relatively processor intensive for a particular device, the identification may be delayed until sufficient processing power is available. The media file recorded may include identification information as determined by the device performing the recording; however, the media file may also include only information pertaining to the nearby devices found such that identification can later be performed independent of the recording operation. Further, while identification of individuals is discussed herein, objects may also include devices that may identify what an object is, such as points-of-interest or objects in a museum. For example, a person may capture a media file of a room of a museum and object identification may be performed according to embodiments of the present invention to determine what objects are featured in the media file.

While many embodiments are described above with a reference to media and multimedia files, the embodiments are equally applicable to media and multimedia streams. Rather than processing a file, a stream may be processed, often in a manner that a first part of the stream is processed while the remaining of the stream is not yet available for processing, as it is not fully received or captured, for example.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a first media file;
identifying a first nearby device using near-field communication; and
analyzing the first media file to identify an object within the first media file based on the identification of the first nearby device.

2. The method according to claim 1, wherein the analyzing includes object recognition.

3. The method according to claim 2, wherein the analyzing comprises increasing the likelihood of recognizing a first object associated with the first nearby device.

4. The method according to claim 3, further comprising generating a probability that is based upon the likelihood of the first object being correctly recognized.

5. The method according to claim 2, further comprising associating the first media file with the first object.

6. The method according to claim 1, further comprising:
capturing a second media file; and
identifying a second nearby device using near-field communications; wherein the analyzing comprises deriving similarity between the first media file and the second media file.

7. The method according to claim 6, wherein the similarity is increased when the first nearby device and the second nearby device are the same or associated with a same object.

8. An apparatus comprising at least one processor and at least one memory including computer program code, the at least one memory and the computer program code configured to, with the at least one processor, cause the apparatus to:
receive a first media file;
identify a first nearby device using near-field communication means; and
analyze the first media file to identify an object within the first media file based on the identification of the first nearby device.

9. The apparatus according to claim 8, wherein the analyzing includes object recognition.

10. The apparatus according to claim 9, wherein the analyzing comprises increasing the likelihood of recognizing a first object associated with the first nearby device.

11. The apparatus according to claim 10, wherein the apparatus is further caused to generate a probability that is based upon the likelihood of the first object being correctly recognized.

12. The apparatus according to claim 9, wherein the apparatus is further caused to associate the first media file with the first object.

13. The apparatus according to claim 8, wherein the apparatus is further caused to:
capture a second media file; and
identify a second nearby device using near-field communication means; wherein the analyzing comprises deriving similarity between the first media file and the second media file.

14. The apparatus according to claim 13, wherein the similarity is increased when the first nearby device and the second nearby device are the same or associated with the same object.

15. A computer program product comprising at least one computer-readable storage medium having computer-executable program code instructions stored therein, the computer-executable program code instructions comprising:
program code instructions for receiving a first media file;
program code instructions for identifying a first nearby device using near-field communication means; and
program code instructions for analyzing the first media file, to identify an object within the first media file based on the identification of the first nearby device.

16. The computer program product according to claim 15, wherein the program code instructions for analyzing the first media file include program code instructions for object recognition.

17. The computer program product according to claim 16, wherein the program code instructions for analyzing the first media file comprise increasing the likelihood of recognizing a first object associated with the first nearby device.

18. The computer program product according to claim 17, further comprising program code instructions for generating a probability that is based upon the likelihood of the first object being correctly recognized.

19. The computer program product of claim 15, further comprising program code instructions for capturing a second media file and program code instructions for identifying a second nearby device using near-field communication means; wherein the analyzing comprises deriving similarity between the first media file and the second media file.

20. The computer program product of claim 19, wherein the similarity is increased when the first nearby device and the second nearby device are the same or associated with the same object.
